(19) United States
(12) Patent Application Publication
(10) Pub. No.: US 2022/0316245 A1
(43) Pub. Date: Oct. 6, 2022

(54) VEHICLE STORAGE DEVICE COMPRISING A LID LOCKING DEVICE

(71) Applicant: FAURECIA INTERIEUR INDUSTRIE, Nanterre (FR)

(72) Inventor: Olivier LE BORGNE, SAINT PAUL (FR)

(21) Appl. No.: 17/711,673

(22) Filed: Apr. 1, 2022

(30) Foreign Application Priority Data
Apr. 1, 2021 (FR) FR 21 03381

(51) Int. Cl. E05B 83/28; B60R 7/04; E05C 3/14; E05C 19/06

(52) U.S. Cl. CPC E05B 83/28; B60R 7/04; E05C 3/14; E05C 19/06

(57) ABSTRACT

A vehicle storage device having a body defining a storage volume, a lid movable in relation to the body between a closed and an open position, and a locking device for the lid which includes a locking member movable between a locked and an unlocked position, and an actuator arranged to move the locking member from the locked position to the unlocked position. The locking member is movably mounted on the body and the actuator is mounted on the lid.

### TECHNICAL FIELD

The present invention relates to a vehicle storage device, of the type comprising:
a body defining a storage volume accessible through an opening,
a lid, movable in relation to the body between a closed position in which the lid closes the opening, and an open position in which the lid provides access to the opening,
a lid locking device comprising a locking member, movable between a locked position in which the lid is held in the closed position, and an unlocked position in which the lid is movable from the closed position to the open position, and an actuator arranged to move the locking member from the locked position to the unlocked position when actuated.

### BACKGROUND

Such a storage device is provided in a center console, dashboard, or other interior trim element of a vehicle, for example. In a known manner, the storage volume of such a storage device may be closed by means of a lid which may be locked in the closed position by means of a locking device to prevent unintended opening of the lid.

The locking device generally comprises a locking member and an actuator of the locking member to allow a user to unlock the locking device when the user wishes to open the lid.

The locking member and the actuator are generally provided on the lid of the storage device and the locking member, formed by a hook for example, interacts with the body of the storage device when the lid is closed to lock the lid in the closed position.

This arrangement is not entirely satisfactory because the locking element extends into the space between the lid and the body opening when the lid is in the open position. A user is then likely to strike the locking element when inserting his or her hand into the opening to access the storage volume, which is uncomfortable and even dangerous if the user is injured during this contact. In addition, the locking element is visible from outside the storage device when the lid is in the open position, which degrades the aesthetics of the storage device.

To overcome these disadvantages, the locking device may be placed in the body, but the bulkiness of the locking device then reduces the storage volume available in the body.

### SUMMARY

One object of the invention is to overcome these drawbacks by providing a storage device that can be securely locked, while having a satisfactory appearance and an appropriately sized storage volume.

To this end, the invention relates to a storage device of the aforementioned type, wherein the locking element is mounted movably on the body, between the locked and unlocked positions and interferes with the lid in the locked position when the lid is in the closed position, the actuator being mounted on the lid and moving the locking element in the unlocked position when the lid is in the closed position and the actuator is operated.

Thus, by providing the locking element on the body and the actuator on the lid, the footprint of the locking device is reduced on both the lid and the body, thereby increasing the available storage space. In addition, by placing the locking element in the body, it is possible to make the locking element hardly visible, if at all, from outside the storage device when the lid is in the open position. Thus, the appearance of the storage device is improved. In addition, a user is less likely to touch the locking element when inserting his or her hand into the storage volume. By providing the actuator in the lid, it is also possible to make the actuator substantially invisible from the exterior of the storage device to further improve the aesthetics of the storage device.

The storage device may further comprise one or more of the following features, taken alone or in any technically feasible combination:
the actuator comprises an actuating surface and a pushing member, the actuating surface being movable by a user along an actuating direction, between a rest position and an actuating position, to move the pushing member in a pushing direction, between an inactive position, when the operating surface is in the rest position, and an active position, in which the pushing member acts on the locking member to move it from the locked position to the unlocked position when the operating surface is in the operating position, the pushing direction being different from the operating direction;
the lid moves in an opening direction between the closed position and the open position, the actuating direction being substantially parallel to the opening direction;
the actuator is rotatably mounted in the lid, the actuating surface and the pushing member extending on either side of the actuator rotational axis, so that movement of the actuating surface in the actuating direction causes movement in the pushing direction of the pushing member;
the locking device comprises an actuator constraining element, constraining the actuating surface towards the rest position;
the lid comprises an abutment surface, the pushing member abutting against said abutment surface in the inactive position;
the actuator is arranged in an internal volume extending within the lid, said internal volume comprising an opening, the locking element being applied to a rim of said opening when the lid is in the closed position and the locking element is in the locked position, the actuator moving the locking element into the opening when actuated to move the locking element from the locked position to the unlocked position;
the actuator extends entirely within the internal volume;
the actuating surface delimits a part of the opening of the internal volume, so that actuation of the actuating surface is accomplished by inserting at least one finger within the internal volume; and
the locking member includes at least one hook projecting from a wall of the body toward the lid, the wall being shaped to comprise a part concealing the at least one hook of the locking member from the exterior of the storage device.

### BRIEF DESCRIPTION OF THE DRAWINGS

Further aspects and advantages of the invention will become apparent from the following description, given by way of example and made with reference to the appended drawings, in which:

FIG. 1 is a schematic perspective representation of a storage device with the lid in the closed position,

FIG. 2 is a schematic perspective representation of a locking device of a storage device according to an embodiment of the invention with the lid in the closed position and the locking element in the locked position, and

FIG. 3 is a schematic cross-sectional representation of the locking device of FIG. 2 during operation of the actuator by a user.

### DETAILED DESCRIPTION

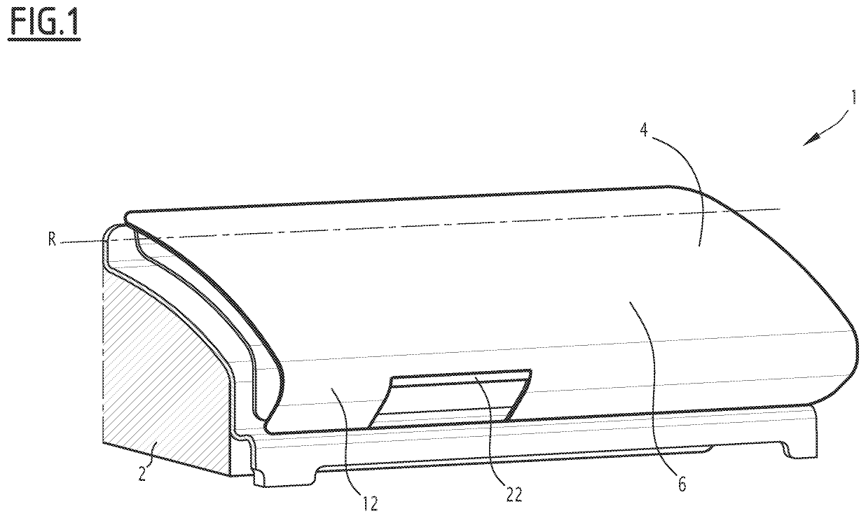

With reference to FIG. 1, a storage device 1 is described, comprising a body 2 and a lid 4, mounted on the body 2.

The body 2 defines a storage volume in which a user can store objects. The body 2 thus comprises at least one wall and a bottom, defining the storage volume between them. Opposite the bottom, for example, the wall or walls also define an opening for access to the storage volume. The body 2 is integrated into a vehicle trim element, for example, or is formed in this trim element, such as a dashboard, for a body 2 forming, for example, a glove box or an upper storage space, a center console, for a body forming, for example, a pocket, a door panel or such like.

The lid 4 is mounted on the body 2 so as to be movable between a closed position, shown in FIG. 1, and an open position. In the closed position, the lid 4 extends over the body 2 so as to close off the opening and make the storage volume inaccessible from outside the storage device 1. In the open position, the lid 4 is at least partially moved away from the opening so as to provide access to the storage volume. The movement of the lid between the closed position and the open position is a rotational movement about an axis R, for example. The movement from the closed position to the open position is along an opening direction, which is formed by an arc of a circle, for example, in the case of a lid rotatably mounted on the body 2. According to the embodiment shown in FIG. 1, the opening direction is oriented towards the top of the vehicle, but it is understood that any direction for opening can be envisaged, in particular depending on the location the storage device 1 is installed in the passenger compartment.

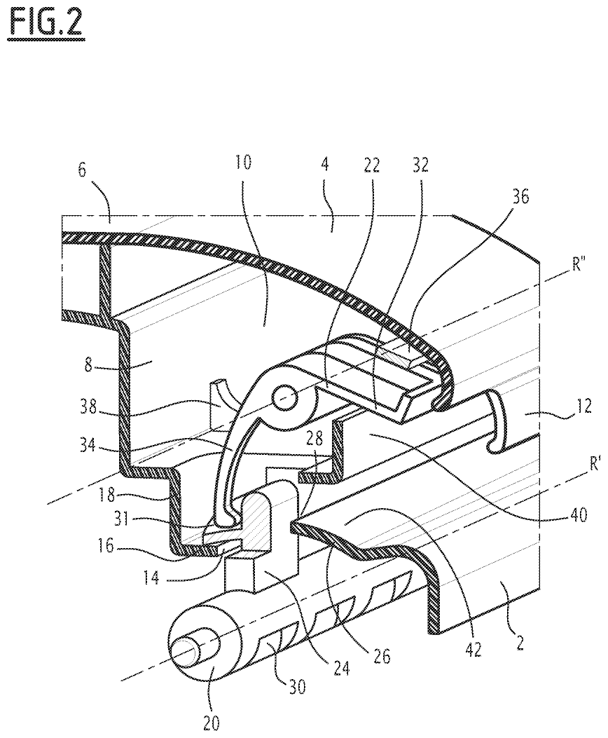

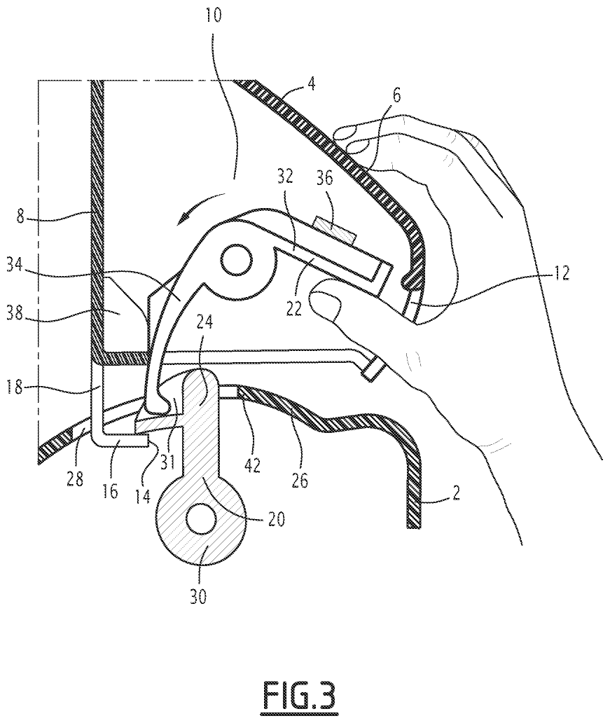

According to one embodiment and as shown in FIGS. 2 and 3, the lid 4 is made in two parts, namely an outer lid part 6 and an inner lid part 8 joined together, by welding for example and in particular by vibration welding, to form the lid. The outer part of the lid 6 forms the visible part of the lid 4 and the storage device 1 in the closed position. The inner part of the lid 8 extends between the outer part of the lid 6 and the body 2 and forms the part of the lid that closes the opening of the body 2 in the closed position. The inner part of the lid 8 is only visible in the open position of the lid 4, for example. The outer part of the lid 6 and the inner part of the lid 8 define at least one internal volume 10 between them, in the vicinity of the edge 12 of the lid 4 that moves away from the body 2 when moving from the closed position to the open position, for example. The internal volume opens to the outside of the lid, for example at the edge 12. The inner part of the lid 8 further comprises an opening 14 opening into the internal volume 10 and extending opposite a part of the body 2. An edge of the opening 14 is formed by a flange 16, for example, extending at the end of a shoulder 18 of the inner part of the lid 8 extending toward the body 2, as shown in FIGS. 2 and 3. In a variant, the lid 4 may be formed in one piece, defining the internal volume 10 and including the opening 14 and the shoulder 18. According to one embodiment, the lid 4 comprises two shoulders 18, each extending in the vicinity of an edge of the lid 4, for example, with these edges being opposite along the width of the lid. One of the shoulders 18 opens into the opening 14 and the other simply extends from the lid, from the inner part of the lid 8 towards the body 2, for example.

The storage device may optionally comprise a constraining device, constraining the lid 4 towards its open position. Thus, in the absence of a force holding the lid in the closed position, the lid then tends to move automatically to the open position

The storage device 1 further comprises a locking device arranged to lock the lid 4 in the closed position, i.e. to prevent the lid from moving unintentionally or involuntarily to the open position, especially when a constraining device constraining the lid to the open position is provided or, more simply, to prevent the lid from moving freely in relation to the body, which could generate unpleasant vibration noises when the vehicle is in motion.

The locking device comprises at least one locking element 20 and at least one actuator 22 of the locking element 20.

The locking element 20 is mounted on the body 2, i.e. it is integral with the body although movable relative to it, as will be described, and does not move with the lid 4 when the lid 4 moves between the open and closed positions.

The locking member 20 comprises a hook 24, for example, projecting from a wall 26 of the body 2 towards the lid 4 and arranged to interact with the lid 4 when in the closed position to block movement of the lid 4 to the open position. The hook 24 passes through an opening 28, for example, extending in the wall 26 opposite the opening 14 of the lid 4. The wall 26 of the body 2 is the wall on which the edge 12 of the lid 4 rests when the lid 4 is in the closed position, for example.

The locking element 20 is movable in relation to the body 2 between a locked position, in which the locking element 20 interacts with the lid 4 when it is in the closed position in order to keep it in that position, and an unlocked position in which the locking element 20 does not interact with the lid 4 so that the lid 4 can move to the open position. The movement of the locking element 20 between the locked position and the unlocked position is a rotational movement about an axis of rotation R′, for example, substantially parallel to the axis of rotation R of the lid 4. For this purpose, the hook 24 is integral with a shaft 30, for example, extending in the wall 26 and mounted on it in a rotatable manner. According to one embodiment, the locking element 20 comprises two hooks 24 integral with the shaft 30 and each extending in the vicinity of one of the ends of the shaft 30, so as to extend opposite the shoulders 18 of the lid.

In the locked position, the hook 24 more particularly interacts with the flange 16 through the opening 14 of the lid 4 to hold the lid 4 in the closed position, as shown in FIGS. 2 and 3. In other words, in the locked position, the hook 24 rests on the flange 16 and opposes movement of the lid 4 in the opening direction. Thus, the locking element 20 interferes with the lid 4 in the locked position and in the closed position of the lid 4. In the unlocked position, the hook 24 is moved away from the flange 16 so that the lid 4 can move to the open position, as the hook 24 no longer interferes with this movement. When two hooks 24 are provided, each engages the flange 16 of one of the shoulders 18 in the locked position and is moved away from that flange in the unlocked position. Movement of the hook 24 interacting with the flange 16 of the shoulder 18 that does not bound the opening 14 is accomplished via the shaft 30 when the other hook 24 is moved from the locked position to the unlocked position by the actuator 22, as will be described later. In other words, movement of the hook 24 from the locked to the unlocked position by the actuator 22 causes rotational movement of the shaft 30, which in turn causes movement of the other hook 24 from the locked to the unlocked position.

The locking device further includes a biasing element (not shown) biasing the locking element 20 to the locked position. Thus, when the locking element 20 is in the unlocked position and the force holding it in that position ceases, the locking element 20 returns to the locked position. Such a restraining element is formed by a torsion spring, for example, mounted about the axis of rotation of the shaft 30 or by a leaf spring acting on the hook 24.

When the lid 4 is closed, i.e. moved from the open to the closed position, the locking element 20 is moved from the locked to the unlocked position by the lid in order to allow the hook 24 to be inserted into the opening 14 beyond the flange 16. To this end, the hook 24 comprises an inclined flange 31, for example, forming a contact surface of the rim 16 when the lid is closed. The contact surface has an arc shape, for example, as more particularly visible in FIG. 3. The flange 16 acts on the inclined flap 31 to move the hook 24 from the locked to the unlocked position. Once the hook 24 is engaged in the opening and the flange no longer acts on the inclined plane 31, the locking element 20 returns to the locked position under the influence of the biasing element and locks the lid 4 in the closed position.

The actuator 22 is mounted on the lid 4, i.e. it is integral with the lid 4 although movable relative to it, as will be described, and moves with the lid 4 when the lid 4 moves between the open and closed positions.

The actuator 22 is arranged to move the locking element 20 from the locked to the unlocked position when operated by a user and the lid 4 is in the closed position. To this end, the actuator 22 is movable between a rest position, in which the actuator 22 is spaced apart from the locking element 20, and an active position, in which the actuator 22 acts on the locking element 20 to move it to the unlocked position. More particularly, the actuator 22 is rotatable about an axis of rotation R″ substantially parallel to the axis of rotation R′ of the locking element 20 between the rest position and the active position. For this purpose, the actuator 22 is rotatably mounted in the internal volume 10 of the lid 4 so as to be accessible to a user through the opening 14.

More particularly, the actuator 22 comprises an actuating surface 32, operable by the user, and a pushing element 34 acting on the locking element 20 when the actuating surface 32 is actuated. The actuator 22 is made in one piece, for example, comprising the actuating surface 32 and the pushing element 34 and mounted rotatably in the internal volume 10 of the lid 4. The actuating surface 32 and the pushing element 34 extend on either side of the axis of rotation R″ and form a non-zero angle between them, for example, so that movement of the actuating surface 32 in one direction causes a movement of the pushing element 34 in another direction. According to the embodiment shown in FIGS. 2 and 3, the actuating surface 32 and the pushing element 34 form an angle close to 90° with each other. This arrangement makes it possible to provide for actuation of the actuation surface 32 along an actuation direction while the pushing element 34 acts on the locking element 20 in a pushing direction different from the actuation direction, thus improving the ergonomics of the locking device. Indeed, it is thus possible to provide that the actuation of the actuation surface 32 is done in an actuation direction that is substantially parallel to the opening direction of the lid 4, as shown in FIGS. 1 and 2, which is particularly intuitive for a user.

The actuator 22 is positioned within the internal volume 10 of the lid 4, for example, such that the actuating surface 32 closes part of the opening 14 of the lid 4, as shown in FIGS. 1 through 3. Thus, a user passing his hand through the opening 14 and inserting at least one finger into the internal volume 10 can actuate the immediately accessible actuating surface 32 to move it in the actuating direction and, in the same movement, move the lid 4 in the opening direction. The actuator 22 thus positioned is also such that the pushing element 34 is opposite the hook 24 of the locking element 20 when the lid 4 is in the closed position. More particularly, the pushing member 34 extends into the shoulder 18 defining the rim 16 on which the hook 24 bears in the locked position of the locking member 20 and the closed position of the lid 4.

While the lid is in the closed position, when the actuation surface 32 is in the rest position, the pushing member 34 is in an inactive position, in which the pushing member 34 is spaced from or flush with the locking member 20, and more particularly the hook 24 that abuts the rim 16 and prevents movement of the lid 4 to the open position. Movement of the actuation surface 32 into the actuation position along the actuation direction causes the pushing element 34 to move along the pushing direction into an active position, in which the pushing element 34 pushes the hook 24 in the pushing direction into the unlocked position, thereby allowing the lid 4 to be opened. The hook 24 and the pushing element 34 may be shaped to interact together in the active position, as shown in FIGS. 1 and 2.

According to one embodiment, the locking device further comprises a constraining element 36 constraining the actuating surface 32 towards the rest position. Thus, when a user stops actuating the actuation surface 32, the actuation surface 32 returns to its rest position, which also causes the push element 34 to return to its inactive position. Such a constraint element 36 is formed by a leaf spring, for example, mounted in the internal volume 10 of the lid 4 opposite the actuation surface 32, as shown in FIGS. 2 and 3. In a variant, the constraint element 36 may be formed by a torsion spring mounted about the axis of rotation R″ of the actuator 22.

According to one embodiment, the lid 2 further comprises an abutment surface extending into the internal volume 10 against which the pushing element 34 bears in the inactive position. The abutment surface is formed by a rib 38, for example, extending into the internal volume 10 opposite the pushing element 34. The abutment surface serves to limit deflection of the actuator in the inactive position so that the actuating surface 32 extends to the desired position in which it extends in continuity with the outer part of the lid 8 so as to present a satisfactory appearance, as more particularly visible in FIGS. 1 and 3.

The appearance of the storage device is furthermore particularly favorable because the pushing element 34 and the locking element 20 can be made almost invisible from the outside of the storage device, even when the storage device is in the open position. This is because the pushing element 34 can extend behind a wall 40 of the outer part of the lid 8, this wall 40 bounding part of the opening 14, as shown in FIG. 2. Thus, the actuator 22 extends entirely within the internal volume 10 and, in the open position, only the end of the pushing element 34 is visible, but only to a limited extent. In addition, the wall 26 may be shaped to include a part 42 obscuring the hook(s) 24 of the locking element 20, as shown in FIGS. 2 and 3. Thus, the hook(s) 24 are particularly well concealed in the open position of the lid 4. In addition, the part 42 of the wall 26 prevents a user from bumping into or scratching on the hook(s) 24 when reaching into the storage device to access the storage volume.

The storage device can also have a large storage volume. Indeed, by separating the actuator 22 and the locking element 20, the footprint of the locking device is reduced, thereby freeing up space to increase the storage volume. Specifically, only a limited amount of space is required in the lid 4 to accommodate the actuator 22, thereby reducing the internal volume 10 and thereby conforming the lid 4 to increase the available storage volume. Similarly, in the body 2, only sufficient space to accommodate the locking element shaft 30 is required in the wall 26, thereby limiting the thickness of the wall 26 and thereby freeing up space to increase the storage volume and/or to reduce the footprint of the storage device.

1. A vehicle storage device comprising:
a body defining a storage volume accessible through an opening,
a lid movable in relation to the body between a closed position, in which the lid closes the opening, and an open position, in which the lid provides access to the opening, and
a device for locking the lid comprising a locking member, movable between a locked position, in which the lid is held in the closed position, and an unlocked position, in which the lid is movable from the closed to the open position, and an actuator arranged to move the locking member from the locked to the unlocked position when actuated,
wherein the locking member is mounted movably on the body between the locked and unlocked positions and interferes with the lid in the locked position when the lid is in the closed position, the actuator being mounted on the lid and moving the locking member to the unlocked position when the lid is in the closed position and the actuator is actuated.

2. The storage device according to claim 1, wherein the actuator comprises an actuating surface and a pushing member, the actuating surface being movable by a user in an actuating direction between a rest position and an actuating position to move the pushing member in a pushing direction between an inactive position, when the operating surface is in the rest position, and an active position, in which the pushing member acts on the locking member to move it from the locked position to the unlocked position when the operating surface is in the operating position, the pushing direction being different from the operating direction.

3. The storage device according to claim 2, wherein the lid moves along an opening direction between the closed position and the open position, the actuation direction being substantially parallel to the opening direction.

4. The storage device according to claim 2, wherein the actuator is rotatably mounted in the lid, the actuating surface and the pushing member extending on either side of the axis of rotation of the actuator so that a movement of the actuating surface in the actuating direction causes a movement in the pushing direction of the pushing member.

5. The storage device according to claim 2, wherein the locking device comprises a constraining element of the actuator, constraining the actuating surface towards the rest position.

6. The storage device according to claim 2, wherein the lid comprises an abutment surface, the pushing element abutting said abutment surface in the inactive position.

7. The storage device according to claim 1, wherein the actuator is arranged in an internal volume extending within the lid, said internal volume comprising an opening, the locking member being applied to a rim of said opening when the lid is in the closed position and the locking member is in the locked position, the actuator moving the locking member into the opening when actuated to move the locking member from the locked position to the unlocked position.

8. The storage device according to claim 7, wherein the actuator extends entirely within the internal volume.

9. The storage device according to claim 7, wherein the actuating surface delimits a part of the opening of the internal volume so that actuation of the actuating surface is accomplished by inserting at least one finger within the internal volume.

10. The storage device according to claim 1, wherein the locking member comprises at least one hook projecting from a wall of the body towards the lid, the wall being shaped to comprise a part concealing the at least one hook of the locking member from the exterior of the storage device.
